(19) United States
(12) Patent Application Publication
(10) Pub. No.: US 2010/0275122 A1
(43) Pub. Date: Oct. 28, 2010

(54) CLICK-THROUGH CONTROLLER FOR MOBILE INTERACTION

(75) Inventors: William A. S. Buxton, Toronto (CA); John SanGiovanni, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/430,878

(22) Filed: Apr. 27, 2009

(51) Int. Cl. G06F 3/048; G06F 3/16; G06F 3/041

(52) U.S. Cl. 715/728; 715/810; 345/173

(57) ABSTRACT

A “Click-Through Controller” uses various mobile electronic devices (e.g., cell phones, media players, digital cameras, etc.) to provide real-time interaction with content (e.g., maps, places, images, documents, etc.) displayed on the device's screen via selection of one or more “overlay menu items” displayed on top of that content. Navigation through displayed contents is provided by recognizing 2D and/or 3D device motions and rotations. This allows users to navigate through the displayed contents by simply moving the mobile device. Overlay menu items activate predefined or user-defined functions to interact with the content that is directly below the selected overlay menu item on the display. In various embodiments, there is a spatial correspondence between the overlay menu items and buttons or keys of the mobile device (e.g., a cell phone dial pad or the like) such that overlay menu items are directly activated by selection of one or more corresponding buttons.

### BACKGROUND

1. Technical Field

A “Click-Through Controller,” provides a mobile device having an integral display screen for use as a mobile interaction tool, and in particular, various techniques for providing an overlay menu on the screen of the mobile device which allows the user to interact in real-time with content displayed on the screen by moving the device to navigate through the content and by selecting one or more of the menu items overlaying specific portions of that content.

2. Related Art

Various techniques exist for navigating over an information space with a hand-held device in a manner analogous to a camera. For example, one such technique, referred to as the “Chameleon” system uses a handheld, or hand moved, display whose position and orientation are tracked using “clutching” and “ratcheting” processes in order to determine what appears on that display. In other words, what appears on the display screen of such systems is determined by tracking the position of the display, like a magnifying glass or moving window that looks onto a virtual scene, rather than the physical world, thereby allowing the scene to be browsed by moving the display.

Further, the concept of Toolglass™ widgets introduced user interface tools that can appear, as though on a transparent sheet of glass, between an application and a traditional cursor. For example, this type of user interface tool can be generally thought of as a movable semi-transparent menu or tool set that is positioned over a specific portion of an electronic document by means of a device such as a mouse or trackball. Selection or activation of the tools is used to perform specific actions on the portion of the document directly below the tool activated. More specifically, such systems typically implement a user interface in the form of a “transparent sheet” that can be moved over applications with one hand using a trackball or other comparable device, while the other hand controls a pointer or cursor, using a device such as a mouse. The tools on the transparent or semi-transparent sheet are called “Click through tools”. The desired tool is placed over the location where it is to be applied, using one hand, and then activated by clicking on it using the other hand. By the alignment of the tool, location of desired effect, and the pointer, one can simultaneously select the operation and an operand. These tools may generally include graphical filters that display a customized view of application objects using what are known as “Magic Lenses”.

Related technologies include “Zoomable User Interfaces” (ZUIs). For example, such techniques generally display various contents on a virtual surface. The user can then zoom and out, or pan across, the surface, in order to reveal content and command. The computer screen becomes like the viewfinder on a camera, or a magnifying glass, pointed at a surface, controlled by the cursor—which is also used to interact with the material thus revealed.

Other related user interface examples include interaction techniques for small screen devices such as palmtop computers or handheld electric devices that use the tilt of the device itself as input. In fact, one such system uses a combination of device tilt and user selection of various buttons to enable various document interaction techniques. For example, these types of systems have been used to implement a map browser to handle the case where the entire area of a map is too large to fit within a small screen. This issue is addressed by providing a perspective view of the map, and allowing the user to control the viewpoint by tilting the display. More specifically, a type of cursor is enabled by selecting a control button to enable the cursor, with the cursor then being moved (left, right, up, or down) on the screen by holding the button and tilting the device in the desired direction of movement. Upon releasing the button, the system then zooms or magnifies the map at the current location of the cursor.

Similar user interface techniques provide spatially aware portable displays that use movement in real physical space to control navigation in the digital information space within. More specifically, one such technique uses physical models, such as friction and gravity, in relating the movement of the display to the movement of information on the display surface. For example, a virtual newspaper was implemented by using a display device, a single thumb button, and a storage area for news stories. In operation, users navigate the virtual newspaper by engaging the thumb button, which acts like a clutch, and moving the display relative to their own body. Several different motions are recognized. Tilting the paper up and down scrolls the text vertically, tilting left and right moves the text horizontally, and pushing the whole display away from or close to the body zooms the text in and out.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “Click-Through Controller,” as described herein, provides a variety of techniques for using various mobile electronic devices (e.g., cell phones, media players, digital cameras, etc.) to provide real-time interaction with content displayed on the device's screen. This interaction is enabled via selection of one or more “overlay menu items” displayed on top of that content. In various embodiments, these overlay menu items are also provided in conjunction with some number of other controls, such as physical or virtual buttons or other controls. Navigation through displayed contents is provided by using various “spatial sensors” for recognizing 2D and/or 3D device positions, motions, accelerations, orientations, and/or rotations, while the overlay menu remains in a fixed position on the screen. This allows users to “scroll”, “pan”, “zoom”, or otherwise navigate the displayed contents by simply moving the mobile device. Overlay menu items then activate predefined or user-defined functions to interact with the content that is directly below the selected overlay menu item on the display.

However, it should also be noted that in various embodiments, one or more menu items that do not directly interact with the content that is directly below the selected menu item are included in the overlay menu. For example, menu items allowing the user to interact with various device functionalities (e.g., power on, power off, initiate phone call, change overlay menu, change one or more individual menu items, or any other desired control or menu option) can be included in the overlay menu.

Note that the following discussion will generally refer to the contents being displayed on the screen of the mobile device as a “document.” However, in this context it should be understood that a “document” is intended to refer to any content being displayed on the screen, 2D or 3D, including, for example, maps, images, spreadsheets, documents, etc., or live content (people, buildings, objects, etc.) being viewed on the display as it is captured by an integral or attached (wired or wireless) camera. Further, it should also be noted that the ideas disclosed in this document are applicable to devices which go beyond conventional hand-held mobile devices, and can be applied to any device with a movable display, such as, for example, a large LCD or other display device mounted on a counter-weighted armature having motion and position sensing capabilities. In either case, terms such as “mobile device” or “mobile electronic device” will generally be used for purposes of explanation.

More specifically, in various embodiments, mobile electronic devices are provided with the capability to sense left-right, forward-backward, and up-down movement and rotations to control the view of a document in memory or delivered dynamically over the network. By analogy, consider looking at an LCD display on a digital camera. By moving the camera left-right or up-down, it is possible to pan over the landscape, or field of view. Furthermore, by moving the camera forward, the user can see more detail (like using a zoom lens to magnify a portion of the scene). Similarly, by moving the camera backward, the user can provide a wider angle view of the scene. However, in contrast to a camera having an optical lens looking out into the physical world, the Click-Through Controller uses a mobile device, such as a cell phone or PDA, for example, in combination with physical motions to control the position of a “virtual lens” that provides a view of a document in that device's memory.

However, it should be noted that in various embodiments, the Click-Through Controller does allow the user to view and interact with objects in the physical world (e.g., control of light switches, electronic devices such as televisions, computers, etc., remotely locking or unlocking a car or other door lock, etc.) via the use of a real-time display of the world around the user captured via a camera, lens, or other image capture device. Such camera, lens, or other image capture device is either integral to the Click-Through Controller, or coupled to the Click-Through Controller via a wired or wireless connection. Further, while such capabilities will be generally described with respect to FIG. 6 in Section 2.5 of this document, the general focus of the following discussion will refer to “documents” for purposes of explanation. Thus, it should be clear that the Click-Through Controller is applicable for use with electronic documents, real-world views and the objects, people, etc. within those views, or any combination of electronic documents and real-world views.

In combination with the position and/or motion based document navigation summarized above, the Click-Through Controller provides a user interface menu as an overlay on the display of the device. By way of analogy, such a controller can be thought of as an interactive head's up display that is affixed to the mobile device's display. Therefore, it could appear as a menu of icons, for example, where the menu is semi-transparent, thereby not obscuring the view of the underlying document. For example, while numerous menu configurations are enabled by the Click-Through Controller, in one embodiment, a grid (either visible or hidden) is laid out on the screen, with an icon (or text) representing a specific menu item or function being provided in one or more of the cells of the grid.

However, rather than allowing the overlay menu to be moved using a cursor or other pointing device, the menu provided by the Click-Through Controller moves with the screen. In other words, while the view of the display screen changes by simply moving the device, as with panning a camera, the overlay menu maintains a fixed position on the display. However, it should be noted that in various embodiments, the overlay menu may also be moved, resized, or edited (by adding, removing, or rearranging icons or menu items).

In general, the functions of the overlay menu are then activated by selecting one or more of those menu items to interact with the content below the selected menu item. More specifically, the user navigates to the desired place on the document (map, image, text, etc.) by moving the device in space, as with a camera. (Unlike the camera, the system can avoid having to hold the device in an awkward position in order to obtain the desired view. This can be accomplished by the inclusion of conventional mechanisms for “clutching” or “ratcheting”, for example, as implemented in the aforementioned Chameleon system. However, because of the superposition of the menu on the document view, the individual menu items will be positioned over specific parts of the document as the user moves the mobile device.

In other words, the user positions the document view and menu such that a specific menu item or icon is directly over top of the part of the document that is of interest. Activating that menu item then causes it to affect the content that is directly below the activated menu item. Moving a sheet of Letraset®, over a document and then rubbing a particular character to stick it in the desired location of that document is a reasonable analogy to what is being described. However, rather than just rubbing, as in the Letraset® case, menu items in the Click-Through Controller can be activated by a number of different mechanisms, including for example, the use of touch screens, stylus type devices, specific keys on a keypad of the device that are mapped to corresponding menu items, voice control, etc. Note also that despite the name, the interaction modalities supported by this technique are not restricted to simple “point and click” type interactions. For example, once selected (clicking down), in various embodiments, the user can move and otherwise exercise continuous control of the operations, such as by subsequent movement of the finger or stylus, the device itself, activating other physical controls on the device, or voice, for example.

In view of the above summary, it is clear that various embodiments of the Click-Through Controller described herein provide a variety of mobile devices having position and/or motion sensing capabilities that allow the user to scroll, pan, zoom, or otherwise navigate that content by moving the device to change a virtual viewpoint from which the content is displayed, while interacting with specific portions of that content by selecting one or more menu items overlaying specific portions of that content. In addition to the just described benefits, other advantages of the Click-Through Controller will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates various program modules for implementing a variety of embodiments of a “Click-Through Controller,” as described herein.

FIG. 2 illustrates the Click-Through Controller implemented within a media player type device, as described herein.

FIG. 3 illustrates the Click-Through Controller implemented within a cell phone type device, as described herein.

FIG. 4 illustrates the Click-Through Controller implemented as a handheld “virtual window,” as described herein.

FIG. 5 illustrates an example of the Click-Through Controller providing a “virtual window” onto a map in memory in a fixed position in a virtual space, with overlay menu items displayed on top of the map for interacting with the map, as described herein.

FIG. 6 illustrates an example of the Click-Through Controller providing a real-time “window” onto a live view of a scene, with overlay menu items displayed on top of the displayed content for interacting with objects in the scene, as described herein.

FIG. 7 illustrates a general system flow diagram that illustrates exemplary methods for implementing various embodiments of the Click-Through Controller, as described herein.

FIG. 8 is a general system diagram depicting a simplified general-purpose computing device having simplified computing and I/O capabilities for use in implementing various embodiments of the Click-Through Controller, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

In general, a “Click-Through Controller,” as described herein, provides a variety of techniques for using various mobile electronic devices (e.g., cell phones, media players, digital cameras, etc.) to provide real-time interaction with content displayed on the device's screen. These mobile electronic devices have position and/or motion sensing capabilities (collectively referred to herein as “spatial sensors”) that allow the user to scroll, pan, zoom, or otherwise navigate that content by moving the device to change a virtual viewpoint from which the content is displayed, while interacting with specific portions of that content by selecting one or more menu items overlaying specific portions of that content.

More specifically, content displayed on the screen of the Click-Through Controller is placed in a fixed (relative or absolute) position in a virtual space. Navigation through the displayed contents is then provided by recognizing one or more 2D and/or 3D device motions or positional changes (e.g., up, down, left, right, forwards, backwards, position, angle, and arbitrary rotations or accelerations in any plane or direction) relative to the fixed virtual position of the displayed document. Note that the aforementioned 2D and/or 3D device motions or positional changes detected by the “spatial sensors” are collectively referred to herein as “spatial changes”. By treating the Click-Through Controller as a virtual window onto the displayed contents, the view of the document on the screen of the Click-Through Controller is changed in direct response to any motions or repositioning (i.e., spatial changes”) of the Click-Through Controller.

Interaction with the displayed contents is enabled via selection of one or more “overlay menu items” displayed on top of that content. In general, the overlay menu remains fixed on the screen, regardless of the motion or position of the Click-Through Controller (although in some cases, the overlay menu, or the various menu items, controls or commands of the overlay menu, may change depending on the current content viewable below the display). This allows users to “scroll”, “pan”, “zoom”, or otherwise navigate the displayed contents by simply moving the mobile device without causing the overlay menu to move on the screen. Consequently, the displayed contents will appear to move under the overlay menu as the user moves the Click-Through Controller to change a virtual viewpoint from which the displayed contents are being displayed on the screen of the mobile device. User selection of any of the overlay menu items activates a predefined or user-defined function corresponding to the selected menu item to interact with the content that is directly below the selected overlay menu item on the display.

Note that the following discussion will generally refer to the contents being displayed on the screen of the mobile device as a “document.” However, in this context it should be understood that a “document” is intended to refer to any content or application being displayed on the screen of the mobile device, including, for example, maps, images, spreadsheets, calendars, web browsers, documents, etc., streaming media such as a live or recorded video stream, or live content (people, buildings, objects, etc.) being viewed on the display as it is captured by an integral or attached (wired or wireless) still or video camera.

1.1 System Overview:

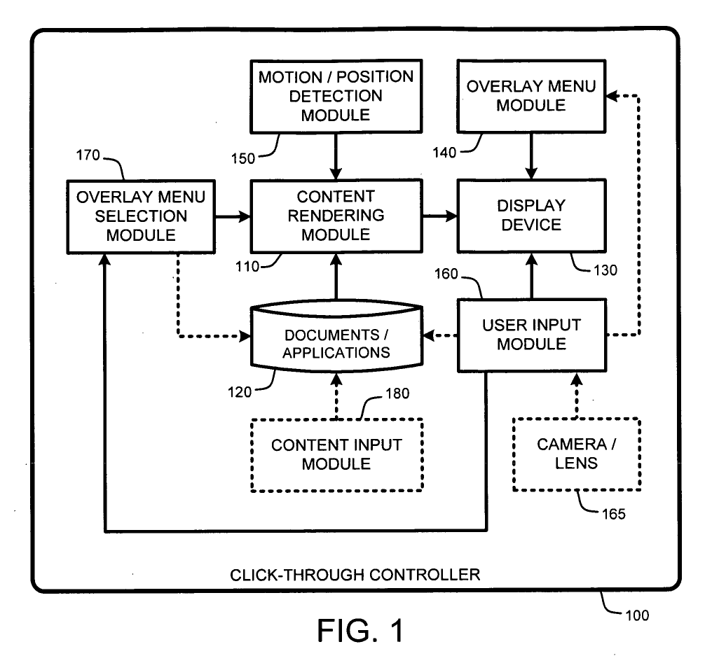

As noted above, the “Click-Through Controller,” provides various mobile devices having motion and/or position sensing capabilities that allow the user to scroll, pan, zoom, or otherwise navigate that content by moving/repositioning the device to change a virtual viewpoint from which the content is displayed, while interacting with specific portions of that content by selecting one or more menu items overlaying specific portions of that content. The processes summarized above are illustrated by the general system diagram of FIG. 1. In particular, the system diagram of FIG. 1 illustrates the interrelationships between program modules for implementing various embodiments of the Click-Through Controller, as described herein. Furthermore, while the system diagram of FIG. 1 illustrates a high-level view of various embodiments of the Click-Through Controller, FIG. 1 is not intended to provide an exhaustive or complete illustration of every possible embodiment of the Click-Through Controller as described throughout this document.

In addition, it should be noted that any boxes and interconnections between boxes that may be represented by broken or dashed lines in FIG. 1 represent alternate embodiments of the Click-Through Controller described herein, and that any or all of these alternate embodiments, as described below, may be used in combination with other alternate embodiments that are described throughout this document.

In general, as illustrated by FIG. 1, the processes enabled by the Click-Through Controller 100 begin operation by using a content rendering module 110 to render documents or applications 120 on a display device 130 of a portable electronic device within which the Click-Through Controller is implemented. As noted above, such portable electronic devices include cell phones, media players, digital cameras, etc. In other words, the Click-Through Controller can be implemented within any device small enough or whose form factor affords it being manipulated in such a way as to support the techniques disclosed herein. However, it should also be clear that the Click-Through Controller described herein may also be implemented in larger non-portable devices, such as a large display device coupled to a movable boom-type device that includes motion-sensing capabilities while allowing the user to easily move or reposition the display in space.

Once the content rendering module 110 has rendered the document or application to the display device 130, an overlay menu module 140 renders a menu as an overlay on top of the contents rendered to the display by the content rendering module. In general, as described in further detail in Section 2.4, the overlay menu provides a set of icons or text menu items that are placed into fixed positions on the display device 130. As the user moves the Click-Through Controller 100 to scroll, pan, zoom, or otherwise navigate the displayed contents, the overlay menu remains in its fixed position such that the displayed contents will appear to move under the overlay menu as the Click-Through Controller is moved. Note that the order of rendering the contents to the display device 130 and providing the overlay menu is not relevant, so long as the overlay menu is either rendered on top of the displayed contents, or those displayed contents are made at least partially transparent to allow the user to see the overlay menu.

As noted above, the user moves or repositions the Click-Through Controller 100 to scroll, pan, zoom, or otherwise navigate the displayed contents. This process is enabled by a motion/position detection module 150 that senses either or both the motion (either constant or in terms of acceleration in any direction) or positional changes of the Click-Through Controller 100 as the user moves or rotates the Click-Through Controller in a 2D or 3D space. As described in further detail in Section 2.3, any of a number of various motion and position sensing modalities may be used to implement the motion/position detection module 150.

In general, the contents rendered by the content rendering module 110 are initially rendered to a fixed point in a virtual space at some initial desired level of magnification or zoom. The display device 130 then acts a “virtual window” that allows the user to see some or all of that content (depending upon the current level of magnification) from an initial viewpoint. Then, by moving the Click-Through Controller 100 in space (i.e., left, right, up, down, etc.), the motion/position detection module 150 will shift the virtual window on the displayed contents in direct response to the user motions. Again, it should be noted that the overlay menu does not shift in response to these user motions.

A user input module 160 is then used to select or otherwise activate one of the overlay menu items when the desired menu item is above or in sufficiently close proximity to a desired portion of the contents rendered on the display device 130. Activation of any one of the overlay menu items serves to initiate a predefined or user-defined function associated with that function via an overlay menu selection module 170. For example, assuming that one of the menu items represents a “directions” command and that command is activated over map content rendered to the display device 130, the Click-Through Controller 100 will provide the user with directions to the point on the map over which the menu item was activated. Note that such directions can either be from a previously selected point on the map, or from the user's current position.

In addition to initiating whatever task or function is associated with a selected menu item, the overlay menu selection module 170, the overlay menu selection module will also cause the content rendering module 110 to make any corresponding changes to content rendered to the display device 130. For example, if the Click-Through Controller 100 is being used to view a web browser on the display device 130, and the user selects a menu item that activates a hyperlink to a new document, content rendering module 110 will then render the new document to the display device.

In addition, in various embodiments of the Click-Through Controller 100, a content input module 180 is provided to receive live or recorded input that is then rendered to the display device 130 by the content rendering module 110. For example, various embodiments of the Click-Through Controller 100 are implemented in a cell phone, PDA, or similar device having an integral or attached (wired or wireless) camera or lens 165 or other image capture device. In this case, a live view from the camera or lens 165 is rendered on the display device 130. The overlay menu module 140 then overlays the menu on that content, as described above.

For example, assuming that the user is pointing the camera of the Click-Through Controller 100 towards a view of a city skyline, various menu items can provide informational functionality, such as, for example, directions to a particular building, phone numbers to businesses within a particular building, etc. by simply moving the Click-Through Controller 100 to place the appropriate menu item over the building or location of interest.

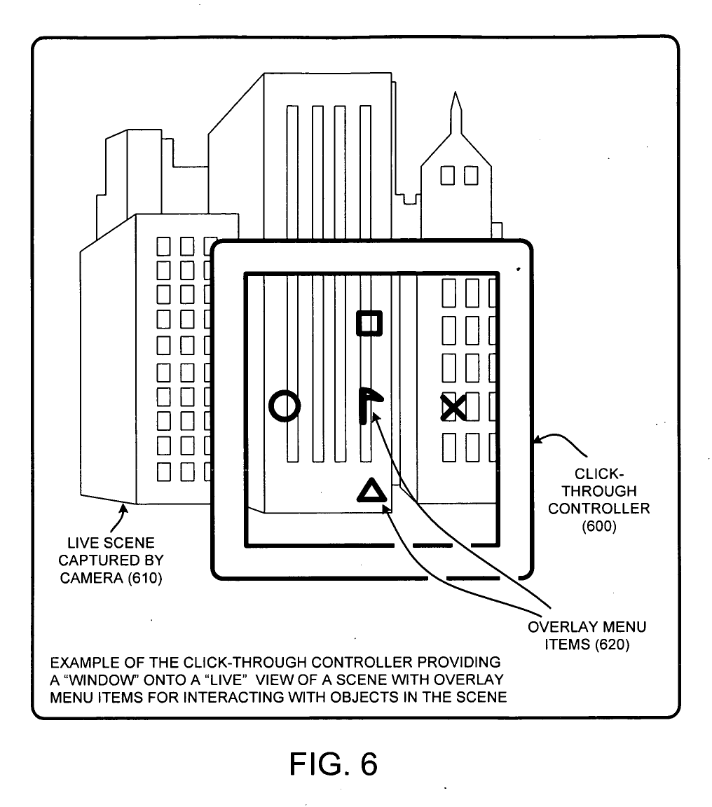

Similarly, in various embodiments, the Click-Through Controller 100 allows the user to view and interact with other objects in the physical world (e.g., control of light switches, electronic devices such as televisions, computers, etc., remotely locking or unlocking a car or other door lock, etc.) by rendering a view captured by the camera or lens 165 on the display device 130 along with corresponding overlay menu items. Note that while such capabilities will be generally described with respect to FIG. 6 in Section 2.5 of this document, the general focus of the following discussion will refer to “documents” for purposes of explanation. However, it should be clear that the Click-Through Controller is applicable for use with electronic documents, real-world views and the objects, people, etc. within those views, or any combination of electronic documents and real-world views.

Further, it should also be noted that in various embodiments of the Click-Through Controller 100, the overlay menu module 140 provides a content specific overlay menu that depends upon the specific content rendered to the display device 130. For example, if the content rendered to the display device 130 is a web browser, then overlay menu items related to web browsing will be displayed. Similarly, if the content rendered to the display device 130 is a map, then overlay menu items related to directions, location information (e.g. phone numbers, business types, etc.), local languages, etc., will be displayed. In addition, as noted above, overlay menu items may also have user defined functionality. Consequently, given the capability for multiple overlay menus and user defined overlay menus, in various embodiments, the user is provided with the capability to choose from one or more sets of overlay menus via the user input module 160.

2.0 Operational Details of the Click-Through Controller:

The above-described program modules are employed for implementing various embodiments of the Click-Through Controller. As summarized above, the Click-Through Controller provides various mobile devices having motion and/or position sensing capabilities that allow the user to scroll, pan, zoom, or otherwise navigate that content by moving the device to change a virtual viewpoint from which the content is displayed, while interacting with specific portions of that content by selecting one or more menu items overlaying specific portions of that content.

The following sections provide a detailed discussion of the operation of various embodiments of the Click-Through Controller, and of exemplary methods for implementing the program modules described in Section 1 with respect to FIG. 1. In particular, the following sections examples and operational details of various embodiments of the Click-Through Controller, including: an operational overview of the Click-Through Controller; exemplary implementations and form factors of the Click-Through Controller; a discussion of exemplary motion and position sensing modalities; overlay menu examples and activation; exemplary applications and uses for the Click-Through Controller; and the use of head tracking relative to transparent or semi-transparent implementations of the Click-Through Controller.

2.1 Operational Overview of the Click-Through Controller:

In general, the Click-Through Controller consists of a relatively small number of basic components, with additional and alternate components being included in further embodiments as described throughout this document. For example, in the most basic implementation, the Click-Through Controller is implemented within a portable electronic device having the capability to sense or otherwise determine motion and/or relative position as the user moves the Click-Through Controller in a 2D or 3D space. In addition, the Click-Through Controller includes a display screen. Content is displayed on the screen, with scrolling, panning, zooming, etc., of those contents being accomplished via user motion of the Click-Through Controller rather than the use of a pointing device or adjustment of scroll bars or the like, as with most user interfaces. In addition, an overlay menu, having a set of one or more icons or text menu items is placed in a fixed position on the display as an overlay on top of the contents being viewed through movement of the Click-Through Controller.

In other words, the Click-Through Controller generally operates as follows:
1. The user navigates through a document by moving or repositioning the physical display. This navigation is enabled by placing the document in a fixed virtual position in a virtual space, then moving the display relative to the document similar to a virtual window panning over and zooming in and out of a scene. Note also that in various embodiments, the “fixed” position in virtual space can be adjusted or changed by the user if desired. This allows the user to select positions or orientations for the Click-Through Controller that may be more comfortable or convenient relative to particular content being displayed on the display device.
2. An “overlay menu” is provided in a fixed position on the display so that moving the display also moves the menu relative to the underlying document which remains “fixed” in its virtual position in a virtual space.
3. Activation of overlay menu items affect what is directly below (or sufficiently close) to an underlying item or region of the document on the display. In other words, activation of any menu item or icon initiates a predefined or user-defined function relative to the particular item or region of the underlying document.
4. The overlay menu items can be activated by various mechanisms, including, but not limited to:
   a. Touch, e.g., a touch screen, or integrated cameras or sensors (laser, infrared, etc.) to identify touch location on the screen to determine which icon or menu item was selected by the user.
   b. Stylus, e.g., a pen or other stylus type device, such as is commonly used with PDA type devices to select particular icons or menu items.
   c. Keys or Buttons, e.g., a phone keypad. For example, in various embodiments, there is a spatial correspondence between the overlay menu items and buttons or keys of the mobile device (e.g., a cell phone dial pad or the like) such that overlay menu items are directly activated by selection of one or more corresponding buttons. For example, pressing “1” on a cell phone keypad will activate the overlay menu item in the upper left quadrant of the display (see discussion with respect to FIG. 3).
   d. Voice, e.g., conventional speech recognition techniques are used to activate particular icons or menu items by speaking a voice command associated with each particular menu item or icon.
   e. Gesture, e.g., a short shake, in a particular direction for example. Analogous to the stylus “flicks” used on tablet PCs in order to change page, etc.

2.2 Exemplary Implementations of the Click-Through Controller:

As noted above, the Click-Through Controller can be implemented within a variety of form factors or devices. Examples of such devices include media players, cell phones, PDA's, laptop or palmtop computers, etc. In general, as long as the device has a display screen, sufficient memory to store one or more documents, and the capability to detect motions or positional changes as the user moves that device, then the device can be modified to implement various embodiments of the Click-Through Controller, as described herein.

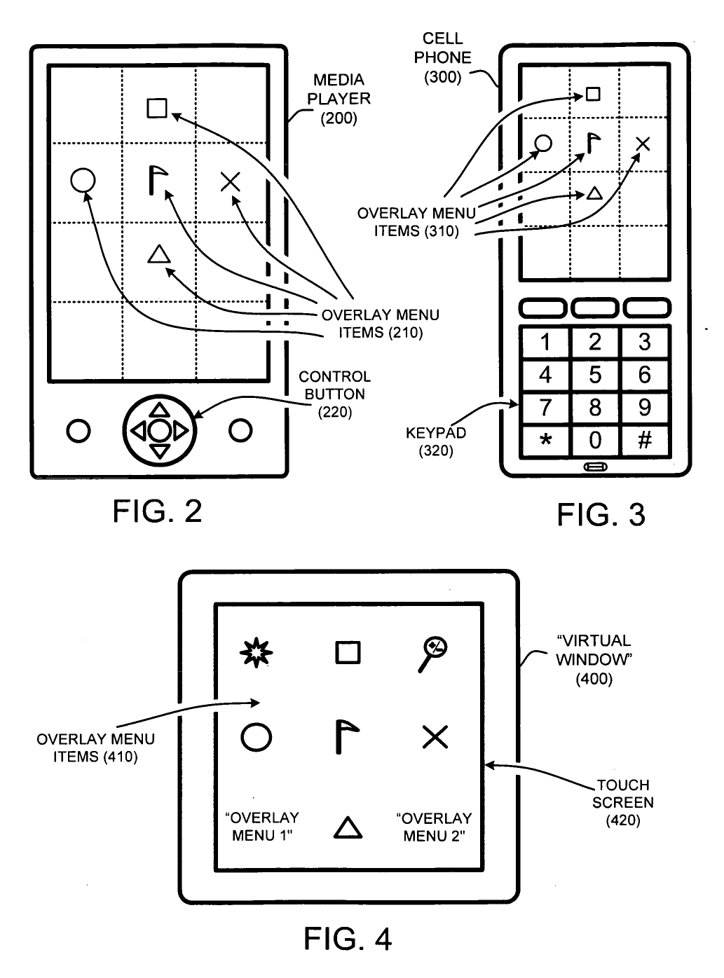

For example, FIG. 2 illustrates the Click-Through Controller implemented within a media player type device 200 that includes motion and/or position sensing capabilities (not shown). This exemplary embodiment shows a 3×4 grid illustrated by broken lines, with various icons representing overlay menu items 210 populating five of cells of the grid. Note that the grid is shown as being visible in this embodiment for purposes of explanation. However, the grid may be either visible or invisible, and may be turned on or off by the user, as desired. Note also that in various embodiments, not all items in the grid are click-through type tools. In fact, some of these items may be conventional menu items. In this example, the media player 200 also includes a control button 220 that recognizes button presses in five directions (up, down, left, right, and center). Consequently, in this embodiment, the control button 220 is mapped to the five icons representing the overlay menu items 210 to allow menu item selection by pressing the control button in the desired place.

Similarly, FIG. 3 illustrates the Click-Through Controller implemented within a cell phone type device 300 that includes motion and/or position sensing capabilities (not shown). As with FIG. 2, this exemplary embodiment also shows a 3×4 grid illustrated by broken lines, with various icons representing overlay menu items 310 populating five of cells of the grid. Again, this grid is shown as being visible in this embodiment for purposes of explanation. However, the grid may be either visible or invisible, and may be turned on or off by the user, as desired. Further, as with the other examples described herein, grid size may be larger or smaller than the 3×4 grid illustrated in FIG. 3. In this example, the cell phone 300 also includes a typical keypad with numbers 0-9 and symbols “*” and “#”. Consequently, in this embodiment, the keypad 320 is mapped to the five icons representing the overlay menu items 310 such that numbers 2, 4, 5, 6 and 8, may be pressed to activate one of the corresponding icons. In other words, there is a spatial correspondence between the overlay menu items 310 and the number keys to allow menu item activation via a simple key press.

FIG. 4 illustrates the Click-Through Controller 400 implemented as a handheld “virtual window”. In particular, in this case, the Click-Through Controller 400 is provided as a dedicated device, rather than being implemented within a device such as media player or cell phone. Again, this “virtual window” embodiment of the Click-Through Controller 400 includes motion and/or position sensing capabilities (not shown). In this case, although the overlay menu items 410 are arranged in a grid type pattern (i.e., nine items in this case, with seven icon type menu items and two text type menu items), the grid is not visible. However, as noted above, the grid may be either visible or invisible, and may be turned on or off by the user, as desired. In this example, the Click-Through Controller 400 includes a touch screen 420 that allows the user to activate any of the overlay menu items 410 either by direct touch, or through the use of a stylus or similar pointing or touch device.

Note that the simple examples illustrated by FIG. 2 through FIG. 4 are intended only to provide a few basic illustrations of the numerous form factors in which the Click-Through Controller may be implemented. Consequently, it should be understood that these examples are not intended to limit the form of the Click-Through Controller to the precise forms illustrated in these three figures.

For example, another embodiment of the Click-Through Controller, not illustrated, is provided in the form of a wristwatch type device wherein a wearable device having a display screen is worn in the manner of a wristwatch or similar device. In fact, such a device can be constructed by simply scaling the Click-Through Controller illustrated in FIG. 4 to the desired size, and adding a band or strap to allow the device to be worn in the manner of a wristwatch. The user would then interact with the wristwatch type Click-Through Controller in a manner similar to that described with respect to FIG. 4.

2.3 Motion and Position Sensing Modalities and Considerations:

As noted above, the Click-Through Controller allows the user to navigate through displayed contents by recognizing 2D and/or 3D device position, motions, accelerations, and/or rotations, while the overlay menu remains fixed on the screen. The position/motion sensing capability of the Click-Through Controller is provided by one or more conventional techniques, including, for example, GPS or other positional sensors, accelerometers, tilt sensors, visual motion sensing (such as, motion-flow or similar optical sensing derived by analysis of the signal from the devices integrated camera), some combination of the preceding, etc. Note that the specific functionality of using various “spatial sensors” for sensing or determining motions, orientations, or positions of a device using techniques such as GPS, accelerometers, etc., is well known to those skilled in the art, and will not be described in detail herein.

For example, in one embodiment, the user can slide the Click-Through Controller (implemented within a PDA or other mobile device, for example) across a tabletop or the surface of a desk, like one would move a conventional mouse, to display different portions of a document in memory. More specifically, consider the tabletop as being “virtually covered” by the document in memory, and the PDA as a “virtual window” onto the tabletop. Therefore, when the user moves the PDA around the tabletop, the user will be able to view different portions of the document since the window provided by the PDA “looks” onto different portions of the document as that window is moved about on the tabletop.

However, it should also be understood that the Click-Through Controller does not need to be placed on a surface in order to move the “window” relative to the document in memory. In fact, as noted above, the Click-Through Controller is capable of sensing motions, positions, accelerations, orientations, and rotations in 2D or 3D. As noted above, these 2D and/or 3D device motions or positional changes are collectively referred to herein as “spatial changes”. Therefore, by placing the document in a fixed position in a virtual space, then treating the Click-Through Controller as a movable virtual window onto the fixed document, any movement of the Click-Through Controller will provide the user with a different relative view of that document.

More specifically, in various embodiments, mobile electronic devices are provided with the capability to sense left-right, forward-backward, and up-down movement and rotations to control the view of a document in memory. By analogy, consider looking at an LCD display on a digital camera. By moving the camera left-right or up-down, it is possible to pan over the landscape, or field of view. Furthermore, by moving the camera forward, the user can see more detail (like using a zoom lens to magnify a portion of the scene). Similarly, by moving the camera backward, the user can provide a wider angle view of the scene. However, in contrast to a camera having an optical lens looking out into the physical world, the Click-Through Controller uses a mobile device, such as a cell phone or PDA, for example, in combination with physical motions to control a “virtual lens” that provides a view of a document in that device's memory.

It should also be noted that the term “zooming” is used herein to refer to cases including both “zooming” and “dollying”. In particular, “zooming” is an optical effect, and consists of changing the magnification factor. In 3D, there is no change in perspective. However, in “dollying,” which is what one does when moving a camera closer or farther from the subject, the effect is quite different from using a zoom lens. In particular, in the case of dollying, as one moves in/out, different material is revealed, due to perspective. For example, as a user moves the Click-Through Controller closer or further from a tree, a camera coupled to the Click-Through Controller may see what was previously obscured behind that tree. While this point may be subtle, it is useful in embodiments where overlay menus are changed as a function of the visible content in the display of the Click-Through Controller, as described in further detail in Section 2.4.

2.4 Overlay Menu:

As noted above, the Click-Through Controller-based processes described herein generally operate by placing a transparent or semi-transparent overlay menu in a fixed position on the display screen of the Click-Through Controller, then moving the Click-Through Controller to reveal particular regions of a document in a fixed position in virtual space. Further, in various embodiments, the overlay menu changes as a function of the content below the display, such that the overlay menus are not permanently fixed. In other words, as with most systems, the overlay menus displayed on the Click-Through Controller can be changed according to the task at hand. In various embodiments, overlay menu changes are initiated explicitly by the user, or, in further embodiments, the actual overlay menu fixed to the display is determined as a function of the contents in the current view.

In combination with the position/motion based document navigation summarized above, the Click-Through Controller provides a user interface menu as an overlay on the display of the device. For example, while numerous menu configurations are enabled by the Click-Through Controller, in one embodiment, a grid (either visible or hidden) is laid out on the screen, with an icon (or text) representing a specific menu item or function being provided in one or more of the cells of the grid.

However, rather than allowing the overlay menu to be moved using a cursor or other pointing device, the menu provided by the Click-Through Controller moves with the screen. In other words, while the view of the display screen changes by simply moving the device, as with panning a camera, the overlay menu maintains a fixed position on the display. However, it should be noted that in various embodiments, the overlay menu may also be moved, resized, or edited (by adding, removing, or rearranging icons or menu items).

In general, the functions of the overlay menu are then activated by selecting on or more of those menu items to interact with the content below the selected menu item. More specifically, the user navigates to the desired place on the document (map, image, text, etc.) by moving the device in space, as with a camera. However, because of the superposition of the menu on the document view, the individual menu items will be positioned over specific parts of the document as the user moves the mobile device. In other words, the user positions the document view and menu such that a specific menu item or icon is directly over top of the part of the document that is of interest. Activating that menu item then causes it to affect the content that is directly below the activated menu item. Note that as discussed above, menu items can be activated by a number of different mechanisms, including for example, the use of touch screens, stylus type devices, specific keys on a keypad of the device that are mapped to corresponding menu items, voice control, etc.

However, it should also be noted that in various embodiments, one or more menu items that do not directly interact with the content that is directly below the selected menu item are included in the overlay menu. For example, menu items allowing the user to interact with various device functionalities (e.g., power on, power off, initiate phone call, change overlay menu, change one or more individual menu items, or any other desired control or menu option) can be included in the overlay menu.

2.5 Exemplary Uses and Applications of the Click-Through Controller:

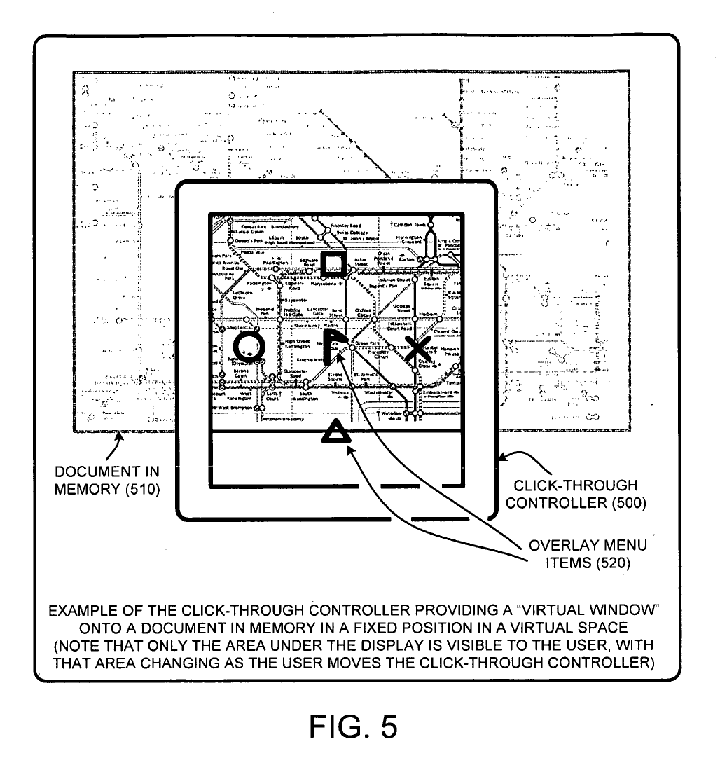

FIG. 5 illustrates an example of the Click-Through Controller 500 providing a “virtual window” onto a map 510 in memory in a fixed position in a virtual space, with overlay menu items 520 displayed on top of the map for interacting with the map. In this example, the user is provided with the capability to view and interact with different portions of the map 510 by simply moving the Click-Through Controller 500 in space and selecting one of the overlay menu items 520 when the desired menu item is on top of (or sufficiently close to) a desired section of the map.

FIG. 6 illustrates an example of the Click-Through Controller 600 providing a real-time “window” onto a live view of a scene 610 captured by a camera (not shown) that is either integral to the Click-Through Controller, or in wired or wireless communication with the Click-Through Controller. In this case, the Click-Through Controller 600 effectively provides an interactive heads-up display view of the world around the user. The user is then able to interact with any portion of the scene 610, or objects within the scene, by simply selecting or otherwise activating one of the overlay menu items 620 when the desired menu item is on top of (or sufficiently close) to a desired object, person, place, etc., in the scene.

For example, as noted above, assuming that the user is pointing the camera of the Click-Through Controller 600 towards a view of a city skyline (as illustrated by FIG. 6), various menu items 620 can provide informational functionality (or any other desired functionality). Examples of such functionality include directions to a particular building, phone numbers to businesses within a particular building, etc., by simply moving the Click-Through Controller to place the appropriate menu item over the building or location of interest, and then selecting or otherwise activating that menu item.

Further examples of interaction with real-world objects include allowing the user to interact with or other control devices such as light switches, power switches, electronic devices such as televisions, radios, appliances, etc. Note that in such cases, the devices with which the user is interacting include wired or wireless remote control capabilities for interacting with the Click-Through Controller 600. For example, with regard to the ‘light switch’ scenario, the user moves the Click-Through Controller 600 such that a light switch is visible in the display, with an appropriate menu item over the switch (such as an “on/off” menu item for example). The user then activates the corresponding menu item, as described above, to turn that light switch on/off in the physical world.

Similar actions using the Click-Through Controller 600 can be used to interact with other electronic devices such as a television, where the user can turn the television on/off, change channels, begin a recording or playback, etc. by selecting overlay menu items corresponding to such tasks while the television is visible on the display of the Click-Through Controller 600. Other similar examples include locking or unlocking doors or windows in a house or other building, enabling, disabling, or otherwise controlling alarm systems, zone-based or whole home lighting systems, zone-based or area wide audio systems, zone-based or area wide irrigation systems, etc. In other words, the Click-Through Controller 600 can act as a type of “universal remote control” for interacting with any remote enabled object or device that can be displayed or rendered on the Click-Through Controller.

Another exemplary use of the Click-Through Controller is to “illuminate” a path to a particular destination. For example, because the Click-Through Controller is capable of sensing device motions and, in various embodiments, physical locations or positions (assuming GPS or other positional capabilities), the Click-Through Controller can be used to “illuminate” a foot path for the user while the user is walking to a particular destination. A simple example of this concept would be for the user to “look through” the Click-Through Controller towards the ground where a virtual footpath would be displayed on the screen as the user walked to indicate the current position of the user relative to final destination as well as the direction the user should be moving to reach the intended destination.

Note that the basic examples discussed above are not intended to limit the scope or functionality of the Click-Through Controller described herein. In fact, in view of the detailed discussions provided herein, it should be clear that the Click-Through Controller can be used for virtually any desired purpose with respect to any document or real-world object that can be rendered or displayed on the display screen of the Click-Through Controller.

2.6 Head Tracking with Semi-Transparent Click-Through Controller:

As noted above, the Click-Through Controller can be implemented within a variety of form factors or devices. One such form factor includes the use of transparent or semi-transparent electronics. For example, as is well known to those skilled in the art, significant progress is being made in the field of transparent or semi-transparent physical devices. In general, such devices use transparent thin-film transistors, based on carbon nano-tubes or other sufficiently small or transparent materials to create transparent or semi-transparent circuits, including display devices. These circuits are either embedded in (or otherwise attached to or printed on) transparent materials, such as plastics, glass, crystals, films, etc. to create see-through displays which can have integral or attached computing capabilities which allow for implementation of the Click-Through Controller within such form factors.

Examples of these types of transparent displays within which the Click-Through Controller is implemented include handheld devices, such as sheets of transparent “electronic paper,” fixed devices such as entire windows (or specific regions of such windows), including windows in homes or buildings, or windshields or canopies for automobiles, aircraft, spacecraft, etc. In such cases, rather than move the Click-Through Controller, the Click-Through Controller instead tracks user head motion and/or eye position relative to the user to determine the parallax of the viewport of the user's perspective on one or more target objects or an overall scene.

For example, assume that a window in a house is a transparent implementation of the Click-Through Controller. The Click-Through Controller will then track the head and or eye motion of a user (or multiple users) standing in front of the window to determine where the user is looking. The Click-Through Controller then provide a semi-transparent heads-up type display on that window relative to objects or content in the user's field of view (people, electronic devices, geographic features, weather, etc.). In other words, the Click-Through Controller senses the parallax of the viewport such that the Click-Through Controller infers the user's perspective on the target object or scene.

A simple example of this concept would be a user looking out of her window towards a sprinkler system in her backyard. The Click-Through Controller would then provide an appropriate overlay menu item relative to the sprinkler which could then be activated or otherwise selected by the user to turn the sprinkler system on or off. Examples of user selection or activation in this case include the use of eye blinks, hand motions, verbal commands, etc. that are monitored and interpreted by the Click-Through Controller to provide the desired action relative to the user selected overlay menu item.

Note that electronic documents can also be displayed on such windows, with user navigation of those documents being based on eye and/or head tracking rather than physical motion of the Click-Through Controller, as described above. However, in such cases, the use of overlay menu items, as discussed with respect to other implementations and embodiments of the Click-Through Controller throughout this document is handled in a manner similar to the case of mobile electronic versions of the Click-Through Controller described herein.

Another example of transparent or semi-transparent implementations of the Click-Through Controller includes the use of transparent displays integrated into a user's eyeglasses or contact lenses (with the glasses or contacts providing either corrective or non-corrective lenses). In particular, in such cases, the eyeglass- or contact lens-based implementations of the Click-Through Controller function similarly to the window-based implementations of the Click-Through Controller described above. In particular, in such cases, the Click-Through Controller tracks the user's head and/or eyes to sense the viewport or viewpoint of the user such that the Click-Through Controller infers the user's perspective on the world around the user. An appropriate overlay menu for people, objects, etc., within the user's view, is then displayed within the user's field of vision on the transparent eyeglass or contact lens-based implementation of the Click-Through Controller. Selection or activation of one or more of those overlay menu items is then accomplished via the use of eye blinks, verbal commands, etc., that are monitored by the Click-Through Controller.

3.0 Operational Summary of the Click-Through Controller:

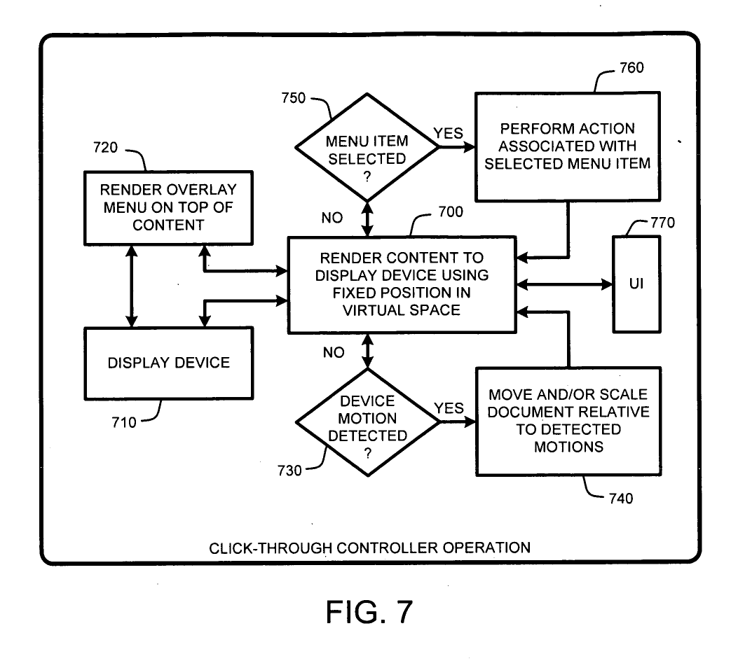

The processes described above with respect to FIG. 1 through FIG. 6, and in further view of the detailed description provided above in Sections 1 and 2 are illustrated by the general operational flow diagram of FIG. 7. In particular, FIG. 7 provides an exemplary operational flow diagram that summarizes the operation of some of the various embodiments of the Click-Through Controller. Note that FIG. 7 is not intended to be an exhaustive representation of all of the various embodiments of the Click-Through Controller described herein, and that the embodiments represented in FIG. 7 are provided only for purposes of explanation.

Further, it should be noted that any boxes and interconnections between boxes that may be represented by broken or dashed lines in FIG. 7 represent optional or alternate embodiments of the Click-Through Controller described herein, and that any or all of these optional or alternate embodiments, as described below, may be used in combination with other alternate embodiments that are described throughout this document.

In general, as illustrated by FIG. 7, the Click-Through Controller begins operation by rendering 700 content (documents, images, etc.) to a display device 710. In addition, the overlay menu is rendered 720 on top of the content. Note that in various embodiments, the overlay menu rendered 720 on top of the content is either completely opaque, or partially transparent. Further, the opacity or transparency of the overlay menu is a user selectable, and user adjustable, feature in various embodiments of the Click-Through Controller.

Once the content and overlay menu have been rendered (700 and 720) to the display device 710, the Click-Through Controller concurrently loops separate checks for both motion and/or position detection and menu item selection.

In particular, the Click-Through Controller evaluates motion and/or position on an ongoing basis to determine whether device motion or position changes have been detected 730. If device motion or positional changes are detected 730, then the Click-Through Controller moves and/or scales 740 the document relative to the detected motions or positional changes, as described in detail above, by re-rendering 700 the content to the display device 710.

In addition, the Click-Through Controller evaluates menu item selection on an ongoing basis to determine whether the user has selected 750 any of the overlay menu items. If a menu item has been selected 750, the Click-Through Controller performs whatever action is associated with the selected menu item, and re-renders 700 the content to the display device 710, if necessary.

The above described processes and loops then continue for as long as the user is operating the Click-Through Controller. Note that the user can select new or different documents or content for display on the Click-Through Controller whenever desired via a user interface 770. In addition, the user can select new or different overlay menus, as discussed above, via the same user interface 770.

4.0 Exemplary Operating Environments:

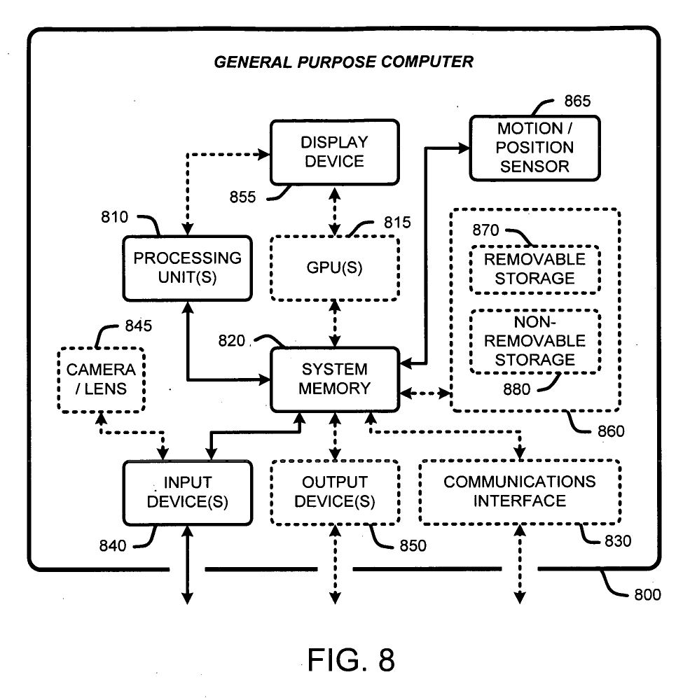

The Click-Through Controller described herein is operational within numerous types of general purpose or special purpose computing system environments or configurations. FIG. 8 illustrates a simplified example of a general-purpose computer system on which various embodiments and elements of the Click-Through Controller, as described herein, may be implemented. It should be noted that any boxes that are represented by broken or dashed lines in FIG. 8 represent alternate embodiments of the simplified computing device, and that any or all of these alternate embodiments, as described below, may be used in combination with other alternate embodiments that are described throughout this document.

For example, FIG. 8 shows a general system diagram showing a simplified computing device. Such computing devices can be typically be found in devices having at least some minimum computational capability, including, but not limited to, hand-held computing devices, laptop or mobile computers, communications devices such as cell phones and PDA's, programmable consumer electronics, minicomputers, video media players, etc. To allow such devices to implement the Click-Through Controller, the device should have a display, sufficient computational capability, some way to sense motion and/or position using various “spatial sensors” and the capability to access documents, electronic files, applications, etc. as described above.

In particular, as illustrated by FIG. 8, the computational capability is generally illustrated by one or more processing unit(s) 810, and may also include one or more GPUs 815. Note that the processing unit(s) 810 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 8 may also include other components, such as, for example, a communications interface 830. The simplified computing device of FIG. 8 may also include one or more conventional computer input devices 840, or other optional components, such as, for example, an integral or attached camera or lens 845. The simplified computing device of FIG. 8 may also include one or more conventional computer output devices 850. The simplified computing device of FIG. 8 may also include storage 860 that is either removable 870 and/or non-removable 880. Note that typical communications interfaces 830, input devices 840, output devices 850, and storage devices 860 for general-purpose computers are well known to those skilled in the art, and will not be described in detail herein.

The simplified computing device 800 also includes a display device 855. As discussed above, in various embodiments, this display device 855 also acts as a touch screen for accepting user input. Finally, as noted above, the simplified computing device will also include motion and/or positional sensing technologies in the form of a “motion/position detection module” 865. Examples of motion and/or position sensors (collectively referred to herein as “spatial sensors”), which can be used singly or in any desired combination, include GPS or other positional sensors, accelerometers, tilt sensors, visual motion sensors (e.g., motion approximation relative to a moving view through an attached or integrated camera), etc.

The foregoing description of the Click-Through Controller has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Click-Through Controller. It is intended that the scope of the invention be limited not by this detailed description, but rather by the claims appended hereto.

What is claimed is:

1. A method for user interaction with electronic documents, comprising steps for:
displaying a view onto a region of an electronic document on a display screen of a portable electronic device, said electronic document being rendered relative to a (position in a virtual space;
displaying an overlay menu in a fixed position on the display screen on top of the electronic document, such that the electronic document is visible under the overlay menu, said overlay menu comprising a plurality of user selectable menu items;
using one or more spatial sensors within the portable electronic device to sense spatial changes of the portable electronic device;
modifying the view of the displayed electronic document relative to the sensed spatial changes of the electronic device, such that spatial changes of the portable electronic device results in shifting the view of the electronic document relative to the position in the virtual space, while maintaining the overlay menu in the fixed position on the display screen; and
wherein at least one of the menu items initiates a predetermined function relative to a particular portion of the electronic document beneath a selected menu item following user interaction with a corresponding one of the menu items.

2. The method of claim 1 further comprising steps for mapping one or more of the menu items to a corresponding button on the portable electronic device, and wherein user interaction with mapped menu items is accomplished by pressing the corresponding button.

3. The method of claim 1 wherein the display screen is a touch screen, and wherein user interaction with menu items is initiated by touching an area of the display screen which includes the selected menu item.

4. The method of claim 1 wherein the user interaction with menu items is initiated by recognizing user speech to activate the selected menu item.

5. The method of claim 1 wherein the display screen has stylus sensing capabilities, and wherein the user interaction with menu items is initiated by using the stylus to interact with an area of the display screen which includes the selected menu item.

6. The method of claim 1 wherein the overlay menu is selected from a set of overlay menus as a function of the type of electronic document being displayed on the display screen.

7. The method of claim 1 wherein the specific menu items comprising the overlay menu are included in the overlay menu as a function of content currently displayed on the display screen.

8. The method of claim 1 wherein one or more of the menu items represents a user definable function.

9. The method of claim 1 wherein each menu item is placed into a separate cell of a grid on the display screen.

10. The method of claim 9 wherein visibility of the grid is user selectable such that the user can turn the visibility of the grid on or off.

11. A system for interacting with digital content, comprising:
a portable electronic device having a display screen and spatial sensor capabilities for detecting spatial changes of the portable electronic device;
a device for rendering digital content to the display screen relative to a fixed position in a virtual space;
a device for rendering a plurality of user selectable menu items in fixed positions on the display screen on top of the digital content, such that the digital content is visible below the user selectable menu items;
a device for changing a view of the digital content on the display screen as a function of sensed spatial changes of the portable electronic device relative to the fixed position in the virtual space; and
a device for executing a function associated with any user selected menu item, and wherein at least one of the menu items initiates a function which interacts with a region of the digital content below that menu item.

12. The system of claim 11 further comprising a device for allowing the user to adjust the fixed position in virtual space.

13. The system of claim 11 further comprising a device for mapping one or more of the menu items to a corresponding key on the portable electronic device such that there is a spatial correspondence between the menu items and the keys, and wherein user selection of mapped menu items is accomplished by pressing the corresponding key.

14. The system of claim 11 wherein the overlay menu is selected from a set of overlay menus as a function of the type of digital content being rendered on the display screen.

15. The system of claim 11 wherein the digital content represents a scene from a digital camera coupled to the portable electronic device, and wherein user selection of one of the menu item allows the user to interact with corresponding objects in the scene being rendered on the display device.

16. The system of claim 11 wherein the digital content represents streaming video media.

17. A user interface implemented within a computing device, comprising:
a display screen;
means for sensing spatial changes of the computing device;
means for allowing the user to select specific digital content;
means for placing the selected digital content into a fixed, user adjustable, virtual position in a virtual space;
means for rendering a view on the display device of an initial region of the selected digital content relative to the fixed virtual position, said initial region corresponding to an initial real position of the computing device;
means for rendering a plurality of user selectable menu items in fixed positions on the display screen on top of the view of the initial region of the selected digital content, such that the region of digital content is visible below the user selectable menu items;
means for changing the view of the region of the digital content in direct correspondence to sensed spatial changes of the computing device relative to the initial position of the computing device and relative to the fixed virtual position of the digital content;
means for providing user selection of any of the menu items; and
means for executing a function associated with any user selected menu item, and wherein at least one of the menu items initiates a function which interacts with an area of the digital content below that menu item.

18. The user interface of claim 17 further comprising means for mapping one or more of the menu items to a corresponding key on the computing device such that there is a spatial correspondence between the menu items and the keys, and wherein user selection of mapped menu items is accomplished by pressing the corresponding key.

19. The user interface of claim 17 wherein the display screen is a touch screen, and further comprising means for allowing user selection of the menu items by touching an area of the display screen which includes the selected menu item.

20. The user interface of claim 17 wherein the computing device further comprises a digital camera, wherein the digital content represents a live view of a scene captured by the digital camera, and wherein user selection of one of the menu item allows the user to interact with corresponding objects in the scene.
